(19) United States
(12) Patent Application Publication
(10) Pub. No.: US 2021/0020123 A1
(43) Pub. Date: Jan. 21, 2021

(54) MANUFACTURING METHOD OF LIQUID CRYSTAL DISPLAY PANEL AND LIQUID CRYSTAL DISPLAY PANEL

(71) Applicants: HKC CORPORATION LIMITED, SHENZHEN (CN); CHONGQING HKC OPTOELECTRONICS TECHNOLOGY CO., LTD., CHONGQING (CN)

(72) Inventor: Chung-kuang CHIEN, CHONGQING (CN)

(21) Appl. No.: 16/320,486

(22) PCT Filed: May 26, 2017
(86) PCT No.: PCT/CN2017/086125

§ 371 Date: Jan. 25, 2019

(30) Foreign Application Priority Data
Dec. 29, 2016 (CN) 201611249216.7

(51) Int. Cl. G09G 3/36; B29C 65/52

(52) U.S. Cl. CPC G09G 3/36; B29C 65/526

(57) ABSTRACT

Provided are a liquid crystal display panel (200) and a manufacturing method thereof. The method comprises: performing pre-baking on a first substrate (201) and a second substrate (202); applying a sealing adhesive (204) to an edge of the first substrate (201) and an edge of the second substrate (202), the sealing adhesive (204) having an absorption spectral wavelength of 300-400 nm; dropping liquid crystal (231) onto the second substrate (202), and applying a sealant to the first substrate (201) and the second substrate (202); assembling the first substrate (201) and the second substrate (202) having been applied with the sealant, and positioning the liquid crystal (231) between the first substrate (201) and the second substrate (202) to form the liquid crystal display panel (200); and irradiating the liquid crystal display panel (200) with a first light source (207) to cure the sealing adhesive (204), thereby forming the finished liquid crystal display panel (200).

### FIELD

The present disclosure relates to a method for manufacturing a liquid crystal display, and more particularly relates to a method for manufacturing a liquid crystal display panel and a liquid crystal display panel.

### BACKGROUND

In a traditional process of manufacturing a liquid crystal display panel, a sealant is very hard to cure and thus can only be cured by multiple baking and curing treatments such as prebaking, ultraviolet curing and bake-curing, which have complex operation processes and require several equipment, leading to high costs for manufacturing the liquid crystal display panel.

### SUMMARY

Accordingly, it is necessary to provide a method for manufacturing a liquid crystal display with simple operation and cost effectiveness, and a liquid crystal display.

A method for manufacturing a liquid crystal display panel includes the steps of:

prebaking a first substrate and a second substrate;

introducing a sealing glue to an edge of the first substrate and an edge of the second substrate, where the sealing glue has an absorption spectrum wavelength ranging from 300 to 400 nm;

dripping liquid crystal to the second substrate, and coating the first substrate and the second substrate with a sealant;

assembling the first substrate and the second substrate coated with the sealant to sandwich the liquid crystal between the first substrate and the second substrate and form at least one liquid crystal display panel; and

irradiating the liquid crystal display with a first light source to cure the sealing glue to form the liquid crystal display panel.

In addition, a liquid crystal display panel is further provided.

The liquid crystal display includes a second substrate, a liquid crystal layer, an alignment layer and a first substrate, which are laminated in turn. An edge of the first substrate and an edge of the second substrate are bonded with each other via a sealing glue, where the sealing glue has an absorption spectrum wavelength ranging from 300 to 400 nm.

In addition, a liquid crystal display panel is further provided.

The liquid crystal module includes a first substrate, a second substrate, a liquid crystal layer, an alignment layer and electrodes. The alignment layer includes a first alignment layer and a second alignment layer. The first substrate, the electrodes, the first alignment layer, the liquid crystal layer, the second alignment layer and the second substrate are laminated in turn. An edge of the first substrate and an edge of the second substrate are bonded with each other via a sealing glue, and the sealing glue has an absorption spectrum wavelength ranging from 300 to 400 nm.

According to the method for manufacturing a liquid crystal display and the liquid crystal display described above, the first substrate and the second substrate are prebaked, and then the sealing glue is introduced to the edge of the first substrate and the edge of the second substrate. The liquid crystal is dripped to the second substrate, the first substrate and the second substrate are coated with the sealant, and the first substrate and the second substrate are assembled to form at least one liquid crystal display. The liquid crystal display is irradiated with the first light source. Since the absorption spectrum wavelength of the sealing glue between the first substrate and the second substrate ranges from 300 to 400 nm, the sealing glue can be favorably cured after being irradiated with the first light source, which do not require for treatments by a coating ultraviolet curing device and a coating baking device. Therefore, the coating ultraviolet curing device and the coating baking device can be omitted, and the process of manufacturing the liquid crystal display panel is simplified with the costs saved.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a cross-sectional view of a liquid crystal display panel according to an embodiment.

FIG. 2 is a flowchart of a method for manufacturing a liquid crystal display panel according to an embodiment.

FIG. 3 is a schematic diagram of a method for manufacturing a liquid crystal display panel according to an embodiment.

### DETAILED DESCRIPTION OF THE INVENTION

For ease of understanding, the present disclosure will be fully described hereinafter with reference to the accompanying drawings. The accompanying drawings illustrate preferred embodiments of the present disclosure. However, the present disclosure can be implemented in various different forms, and should not be construed as limited to the embodiments set forth herein. Rather, these embodiments are provided so that this disclosure will be thorough and complete, and will fully convey the scope of the invention to those skilled in the art.

Unless otherwise defined, meanings of all technical and scientific terms used in this specification are the same as that commonly understood by one of ordinary skill in the art to which the present disclosure belongs. The terms used in this specification of the present disclosure are merely intended to describe specific implementations rather than limit the present disclosure. A term “and/or” used in this specification includes any or all combinations of one or more related listed items.

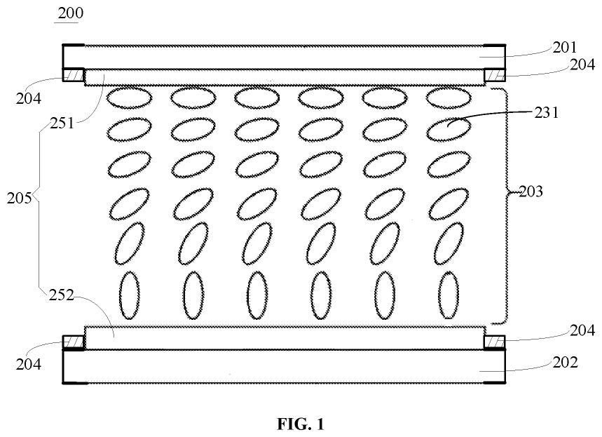

FIG. 1 shows a liquid crystal display panel 200 according to an embodiment. The liquid crystal display panel 200 includes a second substrate 202 (for example, a color filter substrate), a liquid crystal layer 203, an alignment layer 205, and a first substrate 201 (for example, a thin film transistor substrate), which are laminated in turn. An edge of the first substrate 201 and an edge of the second substrate 202 are bonded with each other via a sealing glue 204. The sealing glue 204 has an absorption spectrum wavelength ranging from 300 to 400 nm.

According to the liquid crystal display panel 200 in an embodiment, the sealing glue 204 has an absorption spectrum wavelength ranging from 300 to 340 nm.

The alignment layer 205 includes a first alignment layer 251. The first alignment layer 251 is arranged between the first substrate 201 and the liquid crystal layer 203. The alignment layer 205 further includes a second alignment layer 252. The second alignment layer 252 is arranged between the second substrate 202 and the liquid crystal layer 203.

The liquid crystal display panel 200 further includes electrodes. The electrodes are arranged between the first substrate 201 and the liquid crystal layer 203.

According to the liquid crystal display panel 200 in an embodiment, the liquid crystal layer 203 is composed of at least one liquid crystal material. A dielectric coefficient anisotropy of the liquid crystal material is of negative type.

According to the liquid crystal display panel 200 in an embodiment, the liquid crystal layer 203 is composed of at least one liquid crystal material. A dielectric coefficient anisotropy of the liquid crystal material is of positive type.

Liquid crystal 231 The liquid crystal display panel 200 in an embodiment includes a first substrate 201, a second substrate 202, a liquid crystal layer 203, an alignment layer 205, and electrodes; and the alignment layer 205 includes a first alignment layer 251 and a second alignment layer 252.

The first substrate 201, the electrodes, the first alignment layer 251, the liquid crystal layer 203, the second alignment layer 252, and the second substrate 202 are laminated in turn. An edge of the first substrate 201 and an edge of the second substrate 202 are bonded with each other via a sealing glue 204, where the sealing glue 204 has an absorption spectrum wavelength ranging from 300 to 340 nm.

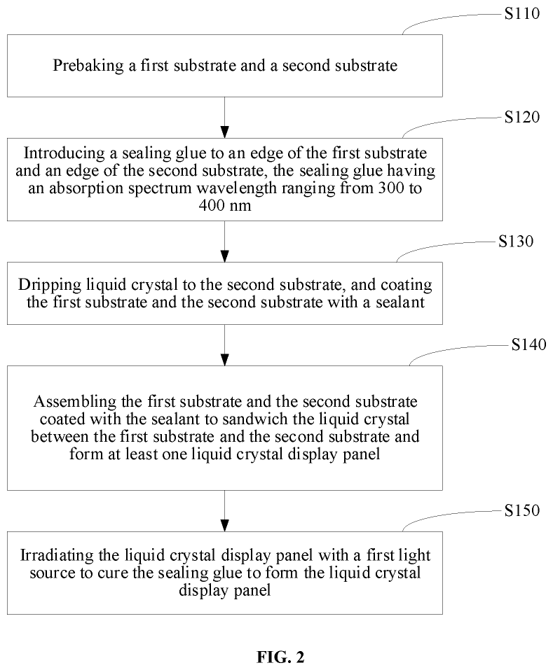

FIG. 2 is a flowchart of a method for manufacturing a liquid crystal display according to an embodiment.

The method for manufacturing a liquid crystal display includes the following steps.

In step S110, a first substrate 201 and a second substrate 202 are prebaked.

The first substrate 201 and the second substrate 202 requires prebaking before bonding, so that residual moisture on the first substrate 201 and the second substrate 202 are removed, and the first substrate 201 and the second substrate 202 are preheated to facilitate subsequent operations and treatments.

In step S120, a sealing glue 204 is introduced to an edge of the first substrate 201 and an edge of the second substrate 202, where the sealing glue 204 has an absorption spectrum wavelength ranging from 300 to 400 nm.

Since liquid crystal 231 needs to be dripped between the first substrate 201 and the second substrate 202, a sealant is needed for bonding the edge of the first substrate 201 and the edge of the second substrate 202, and moreover, the sealant is generally cured by a series of treatment steps such as baking, ultraviolet irradiation, and re-baking.

In this embodiment, the sealing glue 204 is used as the sealant for bonding the edge of the first substrate 201 and the edge of the second substrate 202. With the absorption spectrum wavelength ranging from 300 to 400 nm, which approaches that of the first light source, the sealing glue 204 can be cured rapidly after being irradiated with the first light source. In an embodiment, the sealing glue 204 has an absorption spectrum wavelength ranging from 300 to 340 nm.

In step S130, liquid crystal 231 is dripped to the second substrate 202, and the first substrate 201 and the second substrate 202 are sealant coating processed.

The liquid crystal 231 is arranged between the first substrate 201 and the second substrate 202. The liquid crystal 231 can be arranged between the first substrate 201 and the second substrate 202 via dripping injection manner. The liquid crystal 231 refers to a material state between a liquid state and a crystalline state, and has some properties (such as flowability, and anisotropy) of the liquid and crystal as well as unique properties.

Meanwhile, blank areas of the first substrate 201 and the second substrate 202 are coated with the sealant.

In step S140, the first substrate 201 and the second substrate 202 coated with the sealant are assembled to sandwich the liquid crystal 231 between the first substrate 201 and the second substrate 202, to form at least one liquid crystal display panel.

Specifically, the step that the first substrate 201 and the second substrate 202 coated with the sealant are assembled includes the following substeps.

An alignment layer 205 is arranged between the first substrate 201 and the second substrate 202; and

the first substrate 201, the alignment layer 205, the liquid crystal layer 203, and the second substrate 202 are laminated in turn, and the edge of the first substrate 201 and the edge of the second substrate 202 are bonded with each other via the sealing glue 204.

The liquid crystal layer 203 is aligned via the alignment layer 205 after connecting to an electrode slice of a power supply.

Specifically, the alignment layer 205 includes a first alignment layer 251. The first alignment layer 251 is arranged between the first substrate 201 and the liquid crystal layer 203.

The alignment layer 205 includes a second alignment layer 252. The second alignment layer 252 is arranged between the second substrate 202 and the liquid crystal layer 203.

After the sealing glue 204, the liquid crystal layer 203 and the coating sealant are arranged, the first substrate 201 and the second substrate 202 are required to be assembled, i.e. substrate assembling. Meanwhile, it should be ensured that the liquid crystal layer 203 is between the first substrate 201 and the second substrate 202.

In step S150, the liquid crystal display is irradiated with a first light source to cure the sealing glue 204 and form the liquid crystal display panel 200.

By irradiating the first substrate 201 and the second substrate 202 with the first light source, the sealing glue 204 used between the first substrate 201 and the second substrate 202 for bonding can be cured rapidly, thereby tightly bonding the first substrate 201 and the second substrate 202.

The first light source can be ultraviolet rays. An irradiation time of the first light source ranges from 90 to 110 seconds.

After step S150, the method further includes the following step.

The first substrate 201 and the second substrate 202 are inspected for defects.

After completing the bonding of the first substrate 201 and the second substrate 202, it is necessary to detect whether obvious defects, such as scratches, bulges, and large gaps at the bonding, are present on the surfaces of the first substrate 201 and the second substrate 202.

After the liquid crystal display is irradiated with the first light source, the method further includes the step that electrodes are arranged at two short opposite sides of the second substrate 202 respectively.

Specifically, the electrodes are arranged between the first substrate 201 and the liquid crystal layer 203.

The method for manufacturing the liquid crystal display further includes the step that a black matrix is arranged at a position on the first substrate 201 opposite to the electrodes.

According to all the afore-described embodiments, the liquid crystal layer 203 is composed of at least one liquid crystal material. A dielectric coefficient anisotropy of the liquid crystal material is of negative type.

In another embodiment, the liquid crystal layer 203 is composed of at least one liquid crystal material, A dielectric coefficient anisotropy of the liquid crystal material is of positive type.

According to the afore described embodiments, since the sealing glue 204 having the absorption spectrum wavelength approaching that of the first light source is used for bonding the first substrate 201 and the second substrate 202, the sealing glue 204 can be cured rapidly when the first substrate 201 and the second substrate 202 are irradiated by the first light source and the power supply is connected to align the alignment layer 203, thus an ultraviolet sealant curing machine and a sealant baking and curing machine are not required any more to cure the sealing glue 204. Therefore, the ultraviolet sealant curing machine and the sealant baking and curing machine can be omitted, making the method for manufacturing the liquid crystal display panel easier and more convenient, and saving cost.

In an embodiment, the first substrate 201 is a color filter, and the second substrate 202 is a thin-film transistor.

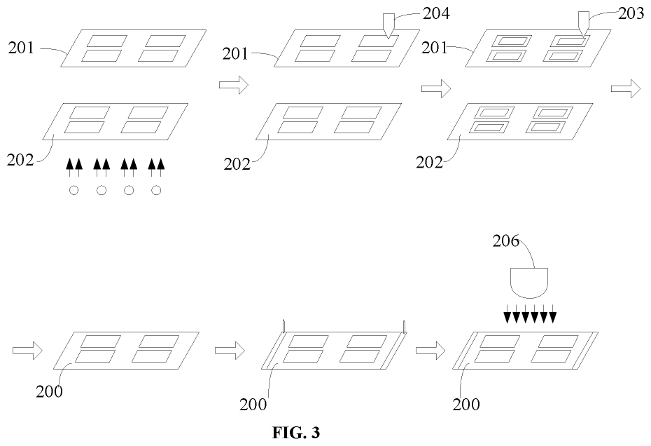

Referring to FIG. 3, the method for manufacturing a liquid crystal display has a working principle as follows: prebaking the first substrate 201 and the second substrate 202, then introducing the sealing glue 201, dripping the liquid crystal 231 to the second substrate 202, and coating with the sealant. At this point, a basic processing of the first substrate 201 and the second substrate 202 is completed, and the first substrate 201 and the second substrate 202 are ready for assembly. That is, the first substrate 201 and the second substrate 202 are assembled to form at least one liquid crystal display panel, which is cut at edge and then irradiated with the first light source 207, thereby completing the manufacturing of the liquid crystal display panel.

According to the afore-mentioned method for manufacturing a liquid crystal display panel and the liquid crystal display panel, the first substrate 201 and the second substrate 202 are prebaked, and then the sealing glue 204 is introduced to the edge of the first substrate 201 and the edge of the second substrate 202. The liquid crystal 231 is dripped to the second substrate 202, the first substrate 201 and the second substrate 202 are coated with the sealant, and the first substrate 201 and the second substrate 202 are then assembled to form at least one liquid crystal display panel 200. The liquid crystal display panel 200 is irradiated with the first light source 207. Since the absorption spectrum wavelength of the sealing glue 204 between the first substrate 201 and the second substrate 202 ranges from 300 to 400 nm, the sealing glue 204 can be favorably cured after being irradiated with the first light source 207, which do not require for treatments of a coating ultraviolet curing device and a coating baking device. Therefore, the coating ultraviolet curing device and the coating baking device can be omitted, thereby making the liquid crystal display simplified and saving the cost.

Various technical features in the foregoing embodiments can be combined randomly. For ease of description, possible combinations of various technical features in the foregoing embodiments are not all described. However, the combinations of the technical features should be considered as falling within the scope recorded in this specification as long as they have no collision with each other.

The foregoing embodiments only describe several implementations of this application, which are described specifically and in detail, however, it should not be construed as a limitation to the patent scope of the present disclosure. It should be noted that, a person of ordinary skill in the art can make various changes and improvements without departing from the ideas of this application, which shall all fall within the protection scope of this application. Therefore, the protection scope of the patent of this application shall be subject to the appended claims.

1. A method for manufacturing a liquid crystal display panel, comprising:
prebaking a first substrate and a second substrate;
introducing a sealing glue to an edge of the first substrate and an edge of the second substrate, wherein the sealing glue has an absorption spectrum wavelength ranging from 300 to 400 nm;
dripping liquid crystal to the second substrate, and coating the first substrate and the second substrate with a sealant;
assembling the first substrate and the second substrate coated with the sealant to sandwich the liquid crystal between the first substrate and the second substrate and form a liquid crystal display panel; and
irradiating the liquid crystal display panel with a first light source to cure the sealing glue to form the liquid crystal display panel.

2. The method according to claim 1, wherein after the irradiating the liquid crystal display with the first light source, the method further comprising:
inspecting the liquid crystal display for defects.

3. The method according to claim 1, wherein the sealing glue has an absorption spectrum wavelength ranging 300 to 340 nm.

4. The method according to claim 1, wherein the step of assembling the first substrate and the second substrate coated with the sealant comprises:
arranging an alignment layer between the first substrate and the second substrate;
laminating the first substrate, the alignment layer, the liquid crystal, and the second substrate in turn, and bonding the edge of the first substrate and the edge of the second substrate with the sealing glue.

5. The method according to claim 4, wherein after the step of coating the first substrate and the second substrate with a sealant, the method further comprising: arranging electrodes at two opposite sides of the second substrate respectively.

6. The method according to claim 5, further comprising: arranging a black matrix at a position on the first substrate opposite to the electrodes.

7. The method according to claim 4, further comprising:
arranging electrodes between the first substrate and the liquid crystal.

8. The method according to claim 4, wherein the alignment layer comprises a first alignment layer, and the first alignment layer is arranged between the first substrate and the liquid crystal.

9. The method according to claim 4, wherein the alignment layer comprising a second alignment layer, and the second alignment layer is arranged between the second substrate and the liquid crystal.

10. The method according to claim 4, further comprising: aligning the liquid crystal via the alignment layer after the liquid crystal is connected to an electrode slice of a power supply.

11. The method according to claim 1, wherein the liquid crystal is composed of at least one liquid crystal material, a dielectric coefficient anisotropy of the liquid crystal material is of negative type.

12. The method according to claim 1, wherein the liquid crystal is composed of at least one liquid crystal material, a dielectric coefficient anisotropy of the liquid crystal material is of positive type.

13. A liquid crystal display panel, comprising:
a liquid crystal layer;
an alignment layer;
a first substrate; and
a second substrate, the second substrate, the liquid crystal layer, the alignment layer and the first substrate being laminated in turn;
an edge of the first substrate and an edge of the second substrate being bonded with each other via a sealing glue, the sealing glue having an absorption spectrum wavelength ranging from 300 to 400 nm.

14. The liquid crystal display panel according to claim 13, wherein the alignment layer comprises a first alignment layer, and the first alignment layer is arranged between the first substrate and the liquid crystal layer.

15. The liquid crystal display panel according to claim 13, wherein the alignment layer comprises a second alignment layer, and the second alignment layer is arranged between the second substrate and the liquid crystal layer.

16. The liquid crystal display panel according to claim 13, further comprising electrodes, the electrodes being arranged between the first substrate and the liquid crystal layer.

17. The liquid crystal display panel according to claim 13, wherein the liquid crystal is composed of at least one liquid crystal material, and a dielectric coefficient anisotropy of the liquid crystal material is of negative type.

18. The liquid crystal display according to claim 13, wherein the liquid crystal is composed of at least one liquid crystal material, a dielectric coefficient anisotropy of the liquid crystal material is of positive type.

19. The liquid crystal display according to claim 13, wherein the liquid crystal layer is also configured to connect an electrode slice of a power supply.

20. A liquid crystal display, comprising:
a first substrate;
a second substrate;
a liquid crystal layer;
an alignment layer, the alignment layer comprising a first alignment layer and a second alignment layer; and
electrodes;
wherein the first substrate, the electrodes, the first alignment layer, the liquid crystal layer, the second alignment layer, and the second substrate are laminated in turn; and
an edge of the first substrate and an edge of the second substrate are bonded with each other via a sealing glue, wherein the sealing glue has an absorption spectrum wavelength ranging from 300 to 400 nm.
